(19) United States
(12) Patent Application Publication
(10) Pub. No.: US 2023/0309513 A1
(43) Pub. Date: Oct. 5, 2023

(54) PET TRACTOR WITH STORAGE BIN AND STORAGE BIN OPENING CONTROL METHOD

(71) Applicant: Dong HAN, Guangdong (CN)

(72) Inventor: Dong HAN, Guangdong (CN)

(21) Appl. No.: 18/024,414

(22) PCT Filed: Oct. 30, 2020
(86) PCT No.: PCT/CN2020/125531

§ 371 Date: Mar. 2, 2023

(30) Foreign Application Priority Data
Sep. 9, 2020 (CN) 202010942252.1

(51) Int. Cl. A01K 27/00; B65H 75/44

(52) U.S. Cl. CPC A01K 27/008; A01K 27/004; B65H 75/4431; B65H 75/4442

(57) ABSTRACT

A pet tractor with a storage bin and a storage bin opening control method. The pet tractor comprises a shell, a rotating wheel, a storage bin, a braking assembly and a locking assembly, wherein the rotating wheel is arranged on the shell, and a traction rope is arranged on the rotating wheel; the storage bin is arranged at one side of the shell; the braking assembly is arranged on the shell, is arranged above the rotating wheel and is used for limiting the rotation of the rotating wheel; the locking assembly is arranged on the shell, located at one side of the braking assembly and used for controlling the braking assembly to be in a braking state and controlling the storage bin to be opened and closed.

### FIELD OF THE INVENTION

The present disclosure relates to the technical field of pet supplies, and more particularly, to a pet tractor with a storage bin and a storage bin opening control method.

### BACKGROUND

Currently, a plurality of families has chosen to raise a pet for an emotional companionship and a life entertainment. Therefore, when going out for a walk with the pet, a traction product including a dog walking rope or a traction rope, and more tractors, shall be equipped to avoid the pet from getting lost or affecting others.

Following a demand of a pet owner on a multi-function for a traction product, a plurality of designs on functional accessories have appeared on the tractors, including a storage bin and more. When the pet owner is operating the storage bin, the storage bin will be pretty close to the pet owner's face, if the traction rope is not fixed, instead, it is extending or retracting quickly, during retracting, a metal buckle on a front end of the traction rope may make an injury or a frighten to the pet owner. In addition, when opening the storage bin, during a sudden telescopic pull of the traction rope, it is also possible to hurt the pet owner, making a pet tractor with a storage bin in the prior art still have a safety hazard.

Therefore, the current technology needs to be improved and developed.

### BRIEF SUMMARY OF THE DISCLOSURE

According to the above described defects, the purpose of the present disclosure is providing a pet tractor with a storage bin and a storage bin opening control method, in order to solve a problem in the prior art that the pet tractor with the storage bin has a safety hazard.

A technical solution of the present disclosure to solve the technical problems is as follows:
a pet tractor with a storage bin, the pet tractor with the storage bin comprising:
a shell;
a rotating wheel, the rotating wheel is arranged on the shell, and the rotating wheel has a traction rope arranged, the rotating wheel is applied to driving the traction rope to extend or contract;
a storage bin, the storage bin is arranged on one side of the shell;
a braking assembly, the braking assembly is arranged on the shell and above the rotating wheel, applied to limiting the rotating wheel from rolling;
a locking assembly, the locking assembly is arranged on the shell and located at one side of the braking assembly, applied to controlling the braking assembly to be in a braking state, and controlling the storage bin to be opened and closed;
wherein when the braking assembly is in a braking state and the locking assembly is in an unlocked state, the braking assembly restricts the rotating wheel from rolling, the braking assembly abuts against the rotating wheel, and the locking assembly restricts the storage bin from being opened; when the braking assembly is in a braking state and the locking assembly is in a locked state, the braking assembly abuts against the rotating wheel, the locking assembly abuts against the braking assembly, and the locking assembly keeps the braking assembly in a braking state, while releasing a restriction to the storage bin, and after the storage bin is opened, the storage bin will restrict the locking assembly from being released from the locked state.

Further, the locking assembly comprises:
a first rotating shaft, the first rotating shaft is arranged on the shell;
a locking member, the locking member is arranged on the first rotating shaft, and a top end of the locking member extends out of the shell while locating on a side of the braking assembly;
a sliding member, the sliding member is arranged on the shell and movably connected with the locking member, the sliding member passes through the braking assembly, and the sliding member may move laterally in the braking assembly through the locking assembly.

Further, the sliding member comprises:
a slider body, the slider body passes through the braking assembly, and both ends of the slider body are arranged on the shell;
a cantilever, the cantilever is arranged on both sides of the slider body, the sliding member connects rotatably with the locking member through the cantilever;
a first limiting portion, the first limiting portion is arranged at a bottom of the slider body;
wherein after the sliding member moves laterally for a certain distance toward the braking assembly through the locking member, the first limiting portion will abut against the braking assembly to keep the braking assembly in the braking state;
a second limiting portion, the second limiting portion is arranged on the slider body and located on a side of the slider body close to the storage bin;
wherein, when the locking assembly is in the unlocked state, the sliding member is in an initial position, and the second limiting portion is applied to restricting the storage bin from being opened, after the sliding member moves laterally toward the braking assembly through the locking member, the second limiting portion releases the restriction on the storage bin.

Further, the pet tractor with the storage bin further comprising:
a first supporting portion, the first supporting portion is arranged on the shell; the first supporting portion has a first groove and a second groove arranged, the second groove connects to the first groove; the slider body passes through the first groove;
a second supporting portion, the second supporting portion is arranged on the shell; the second supporting portion has a third groove arranged, the slider body passes through the third groove;
the slider body has a first limiting rib adapted to the second groove;
wherein, when the sliding member moves laterally toward the braking assembly through the locking member, the first limiting rib is engaged with the second groove.

Further, the braking assembly comprises:
a braking member, a top end of the braking member extends out of the shell and locates on a side of the locking member; wherein the braking member has an accommodation cavity arranged;
a first elastic member, the first elastic member is arranged in the accommodation cavity and abuts against the shell;
a first through hole, the first through hole penetrates through the braking member and connects with the accommodation cavity; the sliding member penetrates through the first through hole and abuts against the braking member by the first limiting portion, to keep the braking assembly in a braking state;
a third limiting portion, the third limiting portion is arranged at a bottom of the braking member, the third limiting portion abuts against the rotating wheel and makes the rotating wheel stop rolling.

Further, the pet tractor with the storage bin further comprises a third supporting portion, the third supporting portion is arranged on the shell, and located under the first elastic member, the first elastic member abuts against the third supporting portion.

Further, the storage bin comprises:
a bin body, the bin body and the shell form an accommodating space;
a bin cover, the bin cover is arranged on the bin body;
a connecting portion, the connecting portion is arranged on the bin cover and rotatably connected with the shell;
a fourth limiting portion, the fourth limiting portion is arranged on the connecting portion, and the second limiting portion abuts against the fourth limiting portion, to limit the storage bin from being opened;
a switch assembly, the switch assembly is arranged on the bin cover and applied to controlling an opening and a closing between the bin body and the bin cover.

Further, the switch assembly comprises:
a base, the base is arranged on the bin cover, the base has a first accommodation groove arranged;
a button, the button is arranged on the first accommodation groove, and slidably connected to the base; wherein the button has a second accommodation groove arranged;
a second elastic member, the second elastic member is arranged in the second accommodation groove, and one end of the second elastic member connects to the button, another end of the second elastic member connects to the base;
a protrusion, the protrusion is arranged on the bin body, and the bin cover is engaged with the protrusion through the button.

Further, the protrusion comprises a first section and a second section, the first section connects to the bin body, the second section connects to the first section;
the button further comprises a buckle and a slot, the buckle is arranged on a bottom of the button, the slot is arranged on an end of the button away from the base; when the button and the protrusion are engaged, the protrusion is accommodated in the slot, and the buckle abuts against the second section.

Further, the pet tractor with the storage bin further comprises a rope outlet, the rope outlet is arranged on the shell; the rotating wheel has a traction rope arranged, and one end of the traction rope passes through the rope outlet.

Based on a same inventive concept, the present disclosure further provides a storage bin opening control method of the pet tractor, applied to the pet tractor with the storage bin as described above, the control method comprises a plurality of steps:
controlling the braking assembly to be in a braking state by applying an external force, to restrict the rotating wheel from rolling, and controlling the locking assembly to be in an unlocked state, to restrict an opening of the storage bin;
controlling the locking assembly to be in a locked state by applying an external force, to restrict the braking assembly keeping in the braking state, while releasing a restriction to the storage bin, now the storage bin is able to be opened;
when it is needed to release the restriction of the braking assembly to the rotating wheel, by applying an external force, the storage bin is controlled to be in a closed state, to release the restriction to the locking assembly by the storage bin, and by applying an external force to control the locking assembly to be in an unlocked state, making the locking assembly release the restriction to the braking assembly;
wherein, when the braking assembly is in a non-braking state and the locking assembly is in an unlocked state, the rolling of the rotating wheel will not be restricted, and the locking assembly will restrict the storage bin from opening; when the storage bin is in an open state, the storage bin restricts the locking assembly to maintain the locked state.

The present disclosure provides a pet tractor with a storage bin and a storage bin opening control method, the pet tractor comprises: a shell; a rotating wheel, the rotating wheel is arranged on the shell, and the rotating wheel has a traction rope arranged, the rotating wheel is applied to driving the traction rope to extend or contract; a storage bin, the storage bin is arranged on one side of the shell; a braking assembly, the braking assembly is arranged on the shell and above the rotating wheel, applied to limiting the rotating wheel to roll; a locking assembly, the locking assembly is arranged on the shell and located at one side close to the braking assembly, applied to controlling the braking assembly to be in a braking state, and controlling the storage bin to be opened and closed; wherein when the braking assembly is in a braking state and the locking assembly is in an unlocked state, the braking assembly abuts against the rotating wheel, the braking assembly restricts the rotating wheel from rolling, and the locking assembly restricts the storage bin from being opened; when the braking assembly is in a braking state and the locking assembly is in a locked state, the braking assembly abuts against the rotating wheel, the locking assembly abuts against the braking assembly, and the locking assembly keeps the braking assembly in a braking state, while releasing a restriction on the storage bin, after the storage bin is opened, the storage bin will restrict the locking assembly to be released from the locked state. The pet tractor with the storage bin provided in the present disclosure, only when the braking assembly is in the braking state and the locking assembly is in the locking state, can the storage bin be opened, at a same time, after the storage bin is opened, the storage bin can also restrict the locking assembly to be released from the locked state, so that when the pet owner is operating the storage bin, it is able to avoid the rotating wheel from rolling suddenly and causing the traction rope extend or retract in a sudden before making hurts to the pet owner, thus improving a usage safety of the pet tractor with the storage bin.

### BRIEF DESCRIPTION OF THE DRAWINGS

In order to explain the embodiments of the present disclosure or the technical solutions in the prior art more clearly, a plurality of drawings that are used in the description on the embodiments or in the prior art will be introduced hereafter. Obviously, the drawings in the following description are only some embodiments of the present disclosure. For those ordinary skilled in the art, without any creative work, other drawings can be obtained based on the structures shown in the present drawings

FIG. 1 illustrates a schematic diagram on an overall structure of a pet tractor with a storage bin in the present disclosure.

FIG. 2 illustrates a schematic diagram on an inner structure of a pet tractor with a storage bin in the present disclosure.

FIG. 3 illustrates an enlarged diagram of A in FIG. 2.

FIG. 4 illustrates a schematic diagram 1 on a partial structure of the pet tractor with the storage bin in the present disclosure.

FIG. 5 illustrates a schematic diagram 2 on another partial structure of the pet tractor with the storage bin in the present disclosure.

FIG. 6 illustrates an enlarged diagram of B in FIG. 5.

FIG. 7 illustrates a schematic diagram of the pet tractor with the storage bin in the present disclosure when the bin cover is closed, the braking assembly is in a non-braking state, and the locking assembly is in a non-locking state.

FIG. 8 illustrates a schematic diagram of the pet tractor with the storage bin in the present disclosure when the bin cover is closed, the braking assembly is in a braking state, and the locking assembly is in a non-locking state.

FIG. 9 illustrates a schematic diagram of the pet tractor with the storage bin in the present disclosure when the bin cover is closed, the braking assembly is in a braking state, and the locking assembly is in a locking state.

FIG. 10 illustrates a schematic diagram of the pet tractor with the storage bin in the present disclosure when the bin cover is open, the braking assembly is in a braking state, and the locking assembly is in a locking state.

FIG. 11 illustrates a schematic diagram 3 on a third partial structure of the pet tractor with the storage bin in the present disclosure.

FIG. 12 illustrates an enlarged view of C in FIG. 11.

FIG. 13 illustrates a schematic flowchart on a storage bin opening control method of the pet tractor in the present disclosure.

Wherein: 1-shell, 11-first supporting portion, 111-first groove, 112-second groove, 12-second supporting portion, 121-third groove, 13-third supporting portion, 14-second rotating shaft, 2-rotating wheel, 3-traction rope, 4-rope outlet, 5-storage bin, 51-bin body, 52-bin cover, 521-third mounting portion, 522-third accommodation groove, 53-connecting portion, 54-fourth limiting portion, 55-switch assembly, 551-base, 5511-first accommodation groove, 552-button, 5521-second accommodation groove, 5522-buckle, 5523-slot, 5524-first curved surface, 5525-second inclined surface, 553-second elastic member, 554-protrusion, 5541-first section, 5542-second section, 5543-second curved surface, 5544-first inclined surface, 6-braking assembly, 61-braking member, 62-accommodation cavity, 63-first elastic member, 64-first through hole, 65-third limiting portion, 7-locking assembly, 71-first rotating shaft, 72-locking member, 73-sliding member, 731-slider body, 732-cantilever, 733-first limiting portion, 734-second limiting portion, 735-first limiting rib, 736-fourth groove.

### DETAILED DESCRIPTION OF EMBODIMENTS

The present disclosure provides a pet tractor with a storage bin, the pet tractor with the storage bin provided in the present disclosure has a more reasonable and safer operation and usage method, being able to protect a pet owner from being hurt in possible. In order to make the purpose, technical solution and the advantages of the present disclosure clearer and more explicit, further detailed descriptions of the present disclosure are stated herein, referencing to the attached drawings and some embodiments of the present disclosure. It should be understood that the detailed embodiments of the disclosure described herein are used to explain the present disclosure only, instead of limiting the present disclosure.

In the implementation method and the scope of the patent application, unless the article is specifically limited in the context, “a” and “the” can generally refer to a singular or a plural.

In addition, the terms “first”, “second”, and more, are only used for descriptive purposes only, instead of being understood as indicating or implying a relative importance or implicitly indicating a number of a plurality of indicated technical features. Thus, the features defined with “first”, and “second” may explicitly or implicitly comprise one or more of these features. In addition, the technical protocols between various embodiments can be combined with each other, but it must be based on what can be achieved by a person of ordinary skill in the art. When the combination of technical solutions is contradictory or impossible to be achieved, it should be considered that such a combination of technical solutions neither exist nor within the scope of protection required by the present disclosure.

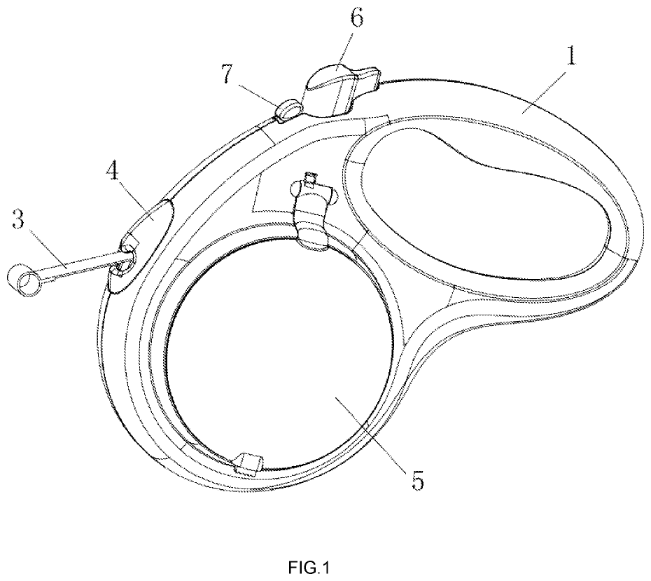

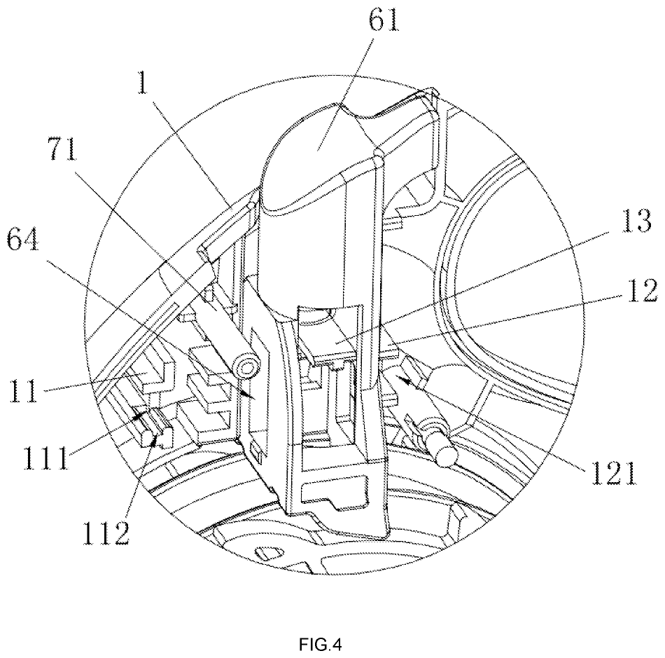

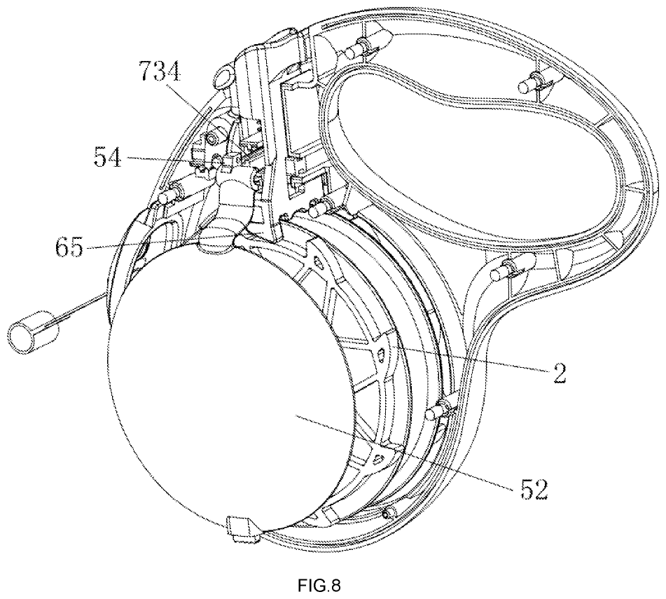

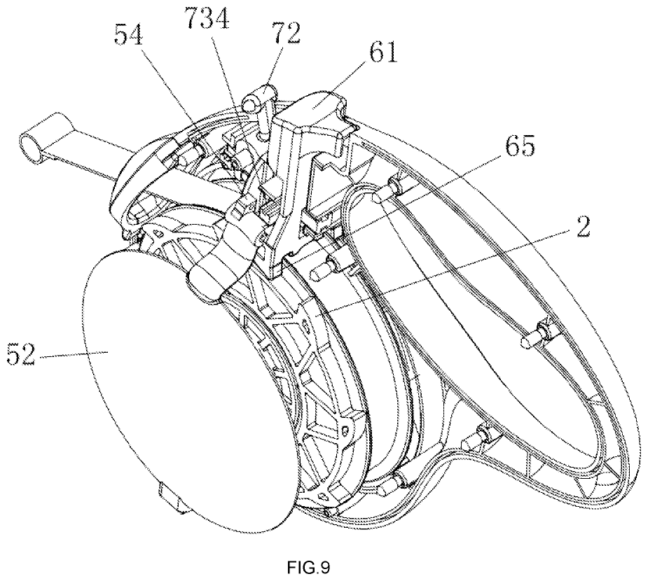

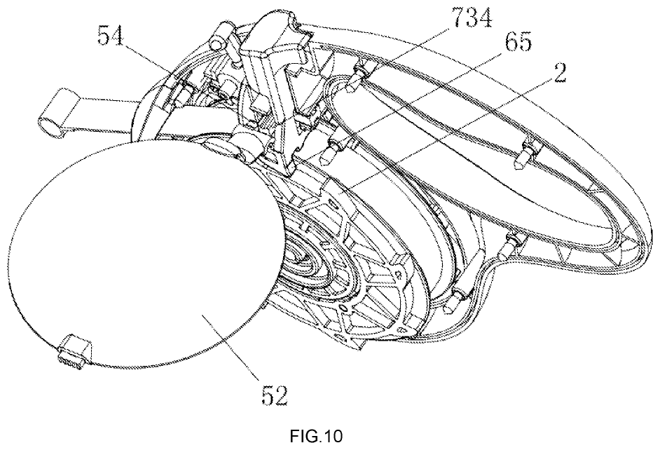

Referencing from FIG. 1 to FIG. 12 together, the present disclosure provides a plurality of preferred embodiments on the pet tractor with the storage bin.

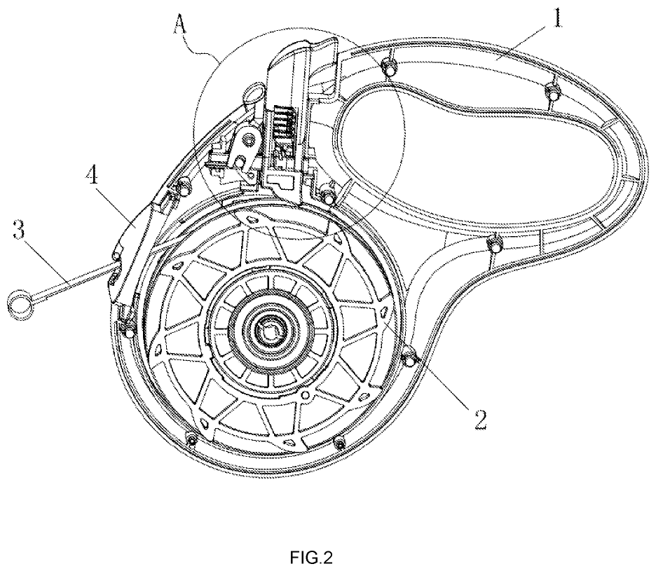

Shown as FIG. 1 and FIG. 2, the present disclosure provides a pet tractor with a storage bin, which comprises a shell 1, a rotating wheel 2, a storage bin 5, a braking assembly 6, and a locking assembly 7. Wherein the shell 1 has a rope outlet 4 arranged, the rotating wheel 2 is arranged on the shell 1, and the rotating wheel 2 has a traction rope 3 arranged, on end of the traction rope 3 passes through the rope outlet 4. The storage bin 5 is arranged on the shell 1 and located on one side of the shell 1; the braking assembly 6 is arranged on the shell 1 and above the rotating wheel 2, applied to limiting the rotating wheel 2 from rolling. The locking assembly 7 is arranged on the shell 1 and located at one side close to the braking assembly, applied to controlling the braking assembly 6 to be in a braking state, and controlling the storage bin 5 to be opened and closed. Wherein when the braking assembly 6 is in a braking state and the locking assembly 7 is in an unlocked state, the braking assembly 6 abuts against the rotating wheel 2, and the braking assembly 6 restricts the rotating wheel 2 from rolling, and the locking assembly 7 restricts the storage bin 5 from being opened; when the braking assembly 6 is in a braking state and the locking assembly 7 is in a locked state, the braking assembly 6 abuts against the rotating wheel 2, the locking assembly 7 abuts against the braking assembly 6, and the locking assembly 7 keeps the braking assembly 6 in a braking state, while releasing a restriction to the storage bin 5, and after the storage bin 5 is opened, the storage bin 5 will restrict the locking assembly 7 from being released from the locked state.

Through the technical protocol stated above, when the braking assembly 6 is released from the braking state, the rotating wheel 2 is able to roll normally, and the traction rope 3 can be stretched and retracted at the rope outlet 4. When the braking assembly 6 is in the braking state, the braking assembly 6 restricts the rotating wheel 2 from rolling, while the traction rope 3 cannot be stretched or retracted. If the locking assembly 7 is also in a locked state, it is able to make the braking assembly 6 keep in the braking state, that is, the rotating wheel 2 can be kept in a stopped state, when the locking assembly 7 releases a restriction to the storage bin 5, the pet owner is able to open the storage bin 5 before making a plurality of operations accordingly. When the pet owner is operating the storage bin 5, since the storage bin 5 is in an opened state, thus the storage bin 5 is able to restrict the locking assembly 7 from being released in the locked state, that is, the rotating wheel 2 is able to be kept in a stopped state when the storage bin 5 is opened, that ensures the pet owner to avoid from being hurt by a sudden extension or shrinking of the traction rope 3 when operating the storage bin 5, thus lowers a safety hazards from the pet tractor and improves a safety of using the pet tractor.

Referencing from FIG. 1 to FIG. 7, in a further implementation of an embodiment, the locking assembly 7 comprises a first rotating shaft 71, a locking member 72 and a sliding member 73. Wherein the first rotating shaft 71 is arranged on the shell 1, the locking member 72 is arranged on the first rotating shaft 71, and a top end of the locking member 72 extends out of the shell 1, and locates on a side of the braking assembly 6, the sliding member 73 is arranged on the shell 1 and movably connected with the locking member 72, while the sliding member 73 passes through the braking assembly 6, the sliding member 73 is able to move laterally in the braking assembly 6 through the locking member 72.

Specifically, the locking member 72 is a crank structure, the shell 1 arranges an outlet corresponding to a position of the locking member 72, a top of the locking member 72 extends out of the shell 1 through the outlet, to facilitate the pet owner to operate. The sliding member 73 comprises a slider body 731, a cantilever 732, a first limiting portion 733 and a second limiting portion 734. Wherein the slider body 731 passes through the braking assembly 6, and both ends of the slider body 731 are arranged on the shell 1, the first limiting portion 733 is a square block shaped structure, the first limiting portion 733 is arranged at a bottom of the slider body 731. In an implementation method, the first limiting portion 733 is a trapezoidal structure, to ensure a strength of the first limiting portion 733. The cantilever 732 is arranged on both sides of the slider body 731, and the sliding member 73 is rotatably connected with the locking member 72 through the cantilever 732. The second limiting portion 734 is arranged on the slider body 731 and located on a side of the slider body 731 close to the storage bin 5. When the sliding member 73 moves laterally toward the braking assembly 6 for a certain distance through the locking member 72, that is, when the locking member 72 is pushed to move the sliding member 73 toward the braking assembly 6, the first limiting portion 733 will abut against the braking assembly 6, to keep the braking assembly 6 in the braking state, that is, now the locking assembly 7 is in the locked state. It should be noted that, when the sliding member 73 is in an initial position (the locking assembly 7 is in an unlocked state), the second limiting portion 734 is applied to restricting the storage bin 5 from being opened, that is, If the storage bin 5 is opened, it will have an interference with the second limiting portion 734. Then, when the sliding member 73 moves laterally toward the braking assembly 6 through the locking member 72, the second limiting portion 734 will release the restriction to the storage bin 5, that is, now the storage bin 5, after being opened, will not have an interference with the second limiting portion 734.

Referencing from FIG. 2 to FIG. 4, in a further implementation method of an embodiment, the pet tractor with the storage bin 5 further comprises a first supporting portion 11 and a second supporting portion 12, the first supporting portion 11 and the second supporting portion 12 are intervally arranged on the shell 1. Wherein the first supporting portion 11 has a first groove 111 and a second groove 112 arranged, one end of the slider body 731 passes through the first groove 111, the second groove 112 connects to the first groove 111, the second supporting portion 12 has a third groove 121 arranged, another end of the slider body 731 passes through the third groove 121. The slider body 731 has a first limiting rib 735 arranged adapting to the second groove 112. Wherein when the sliding member 73 moves laterally toward the braking assembly 6 through the locking member 72, the first limiting rib 735 will engage together with the second groove 112.

Specifically, the first groove 111 and the third groove 121 are a limiting groove of the sliding member 73, one end of the slider body 731 penetrates the first groove 111, another end of the slider body 731 penetrates the third groove 121 after passing through the braking member 61, to complete an installation of the sliding member 73. Wherein, under a limiting effect of the first groove 111 and the third groove 121 to a limiting body, when the locking member 72 drives the sliding member 73 to move, it is possible to restrict the slider body 731 to move laterally toward the braking assembly 6, and after the sliding member 73 moves laterally for a certain distance toward the braking assembly 6 through the locking member 72, the first limiting rib 735 is engaged together with the second groove 112. At this time, the locking assembly 7 has already been in a locked state. In the present embodiment, the first limiting rib 735 and the second groove 112 are engaged together, which is able to prevent the slider body 731 from moving, to ensure a stability of the locked state of the locking assembly 7. More specifically, both a surface of the first limiting rib 735 and a side of the first supporting portion 11 close to the first limiting rib 735 are both a circular arc surface, to facilitate the first limiting rib 735 sliding into the second groove 112 when the slider body 731 moves.

Referencing from FIG. 2 to FIG. 9, a further implementation method of an embodiment, wherein an end of the slider body 731 close to the first supporting portion 11 has a fourth groove 736 arranged, when the slider body 731 moves, under an extrusion of the first supporting portion 11, the slider body 731 may generate a certain deformation, to ensure that the first limiting rib 735 is able to slide into the second groove 112.

Referencing from FIG. 2 to FIG. 4, a further implementation method of an embodiment, wherein the braking assembly 6 comprises a braking member 61, a first elastic member 63, a first through hole 64, and a third limiting portion 65. Wherein a top end of the braking member 61 extends out of the shell 1, and locates on a side of the locking member 72; wherein the braking member 61 has an accommodation cavity 62 arranged, the first elastic member 63 is arranged in the accommodation cavity 62 and abuts against the shell 1, the first through hole 64 is arranged along a width direction of the braking member 61, and penetrates through the braking member 61, the sliding member 73 penetrates through the first through hole 64 and abuts against the braking member 61 by the first limiting portion 733, to keep the braking assembly 6 in a braking state. The third limiting portion 65 is arranged at a bottom of the braking member 61, by the third limiting portion 65 abuts again the rotating wheel 2, it makes the rotating wheel 2 stop rolling.

Specifically, a top end of the braking member 61 extends out of the shell 1 through an opening on the shell 1, and the braking member 61 is arranged adjacent to the locking member 72, while a height of the braking member 61 extending out of the shell 1 is greater than that of the locking member 72 extending out of the shell 1, so the pet owner will not touch the locking member 72 during using, convenient for the pet owner to operate with one hand.

More specifically, in an implementation method, the first elastic member 63 may be a compression spring, the compression spring is arranged in the accommodation cavity 62 of the braking member 61, and one end of the compression spring abuts against the top of the braking member 61 (the compression spring is installed in the braking member 61, and a height of an inner space of the braking member 61 is smaller than a length of the compression spring, so the compression spring is compressed), another end will abut again the shell 1. The first through hole 64 is a square shaped through hole, the first through hole 64 penetrates the braking member 61 along a width direction of the braking member 61, and connects to the accommodation cavity 62, while the sliding member 73 penetrates through the first through hole 64. When pressing the braking member 61, the braking member 61 squeezes the compression spring, after the compression spring is compressed, the braking member 61 moves downward for a certain distance, so the third limiting portion 65 on the braking member 61 will be able to touch the rotating wheel 2, thus being able to restrict the rotating wheel 2 from a further rotation, while the braking assembly 6 is in a braking state. Then when the braking member 61 is in the pressed state and is pressed to an end, the third limiting portion 65 of the braking member 61 has already touched the rotating wheel 2. In the braking state, a top of the braking member 61 goes down and approaches the locking member 72, making a hand be able to control a position of the locking member 72. If the sliding member 73 is driven to move toward the braking member 61 by the locking member 72, the first limiting portion 733 arranged on the slider body 731 will also move toward the braking member 61, since the braking member 61 has already generated a relative displacement downwards, thus the braking member 61 will not interfere with the first limiting portion 733, that is, the first limiting portion 733 is able to enter the first through hole 64 before abutting against the braking member 61. Now if the hand releases the braking member 61 or reduces a downward pressure on the braking member 61. then the braking member 61 will move upward under an action of the compression spring, however when moving until touching the first limiting portion 733, no more movement can be continued, now the braking member 61 still maintains a contact with the rotating wheel 2, preventing the rotating wheel 2 from rolling, but keeping in the braking state.

It should be noted that, since the rotating wheel 2 has a plurality of teeth (generally it is 8), under an action of an external tension and a force of a coil spring, the rotating wheel 2 will roll, the traction rope wound on the rotating wheel 2 will be reversed under a drive of the coil spring. Due to an angular difference between the teeth of the rotating wheel 2, after the braking member 61 is pressed down, it will stay between the teeth, thus the teeth will be blocked by a rear end of the third limiting portion on the braking member 61, and no longer being able to continue moving.

Referencing from FIG. 2 to FIG. 4, a further implementation method of an embodiment, wherein the pet tractor with the storage bin 5 further comprises a third supporting portion 13, the third supporting portion 13 is arranged on the shell 1, and located under the first elastic member 63, the first elastic member 63 abuts against the third supporting portion 13. Specifically, the third supporting portion 13 is a board shaped structure, the third supporting portion 13 applies a supporting action onto the first elastic member 63, to make the first elastic member 63 generate a deformation before saving energy when subjecting to a force. After releasing the action force to the braking member 61, the braking member 61 is able to move upward under a rebound action of the first elastic member 63, thereby releasing the braking state of the braking assembly 6, so that the traction rope 3 may extend or retract freely through the rope outlet 4.

Referencing from FIG. 1 to FIG. 10, a further implementation method of an embodiment, wherein the storage bin 5 comprises a bin body 51, a bin cover 52, a connecting portion 53, a fourth limiting portion 54, and a switch assembly 55. Wherein the bin body 51 and the shell 1 form an accommodating space, generally, the accommodating space may be used to place a key, an emergency product, a change, and more. The bin cover 52 is arranged on the bin body 51, the connecting portion 53 is arranged on the bin cover 52 and rotatably connected with the shell 1, the fourth limiting portion 54 is arranged on the connecting portion 53, and the second limiting portion 734, by abutting against the fourth limiting portion 54, limits the storage bin 5 from being opened. The switch assembly 55 is arranged on the bin cover 52, and applied to controlling an opening and a closing between the bin body 51 and the bin cover 52.

Specifically, the switch assembly 55 is able to control the bin cover 52 to be opened or closed. The connecting portion 53 is a rotating arm of the bin cover 52, the shell 1 has a second rotating shaft 14 arranged, the bin cover 52 is rotatably connected to the second rotating shaft 14 on the shell 1 through the connecting portion 53, and the fourth limiting portion 54 is a block shaped structure, while the fourth limiting portion 54 is arranged on the connecting portion 53. When the locking assembly 7 is in the unlocked state, the fourth limiting portion 54 is facing normally the second limiting portion 734. Therefore, if the bin cover 52 is opened at this time, the fourth limiting portion 54 will generate an interference with the second limiting portion 734, thus when the locking assembly 7 is in the unlocked state, the storage bin 5 cannot be opened, while the locking assembly 7 is in the locked state, the sliding member 73 moves toward the braking member 61 a certain distance, now the fourth limiting portion 54 and the second limiting portion 734 have been already staggered, therefore, if the bin cover 52 is opened at this time, the fourth limiting portion 54 and the second limiting portion 734 will not generate the interference.

It is understandable that when the bin cover 52 is in the opened state, if the locking member 72 is pushed to move, the locking block will drive the sliding member 73 to move, but the sliding member 73, due to being blocked by the fourth limiting portion 54, cannot continue to move, the locking member 72 cannot continue to move either, the first limiting portion 733 will still within a interference range of the braking member, the braking member is still unable to move, and the braking member is still in the braking state, that ensures that when the bin cover 52 is not closed, the locking assembly 7 cannot be released from the locked state, and the braking assembly 6 cannot be released from the braking state.

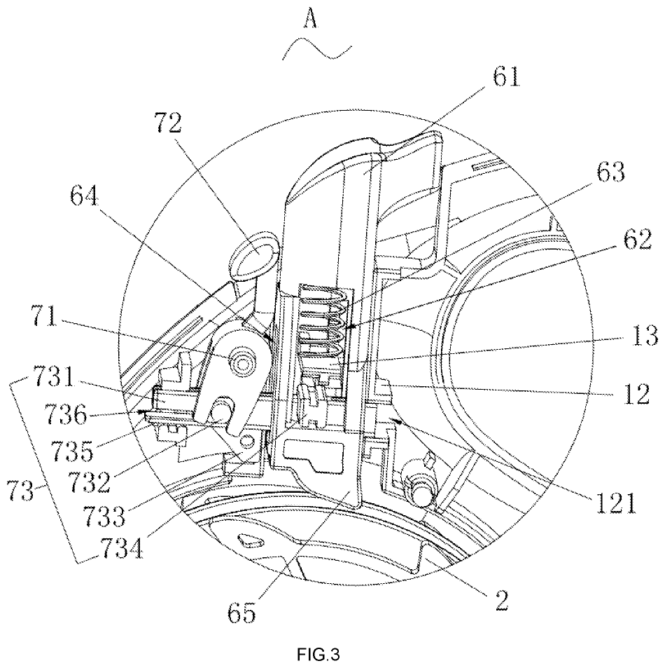

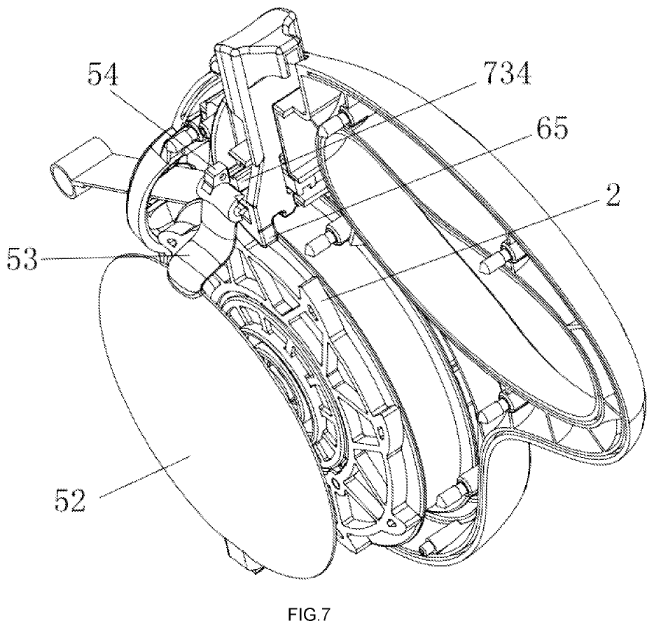

It should be noted that, shown as FIG. 3 and FIG. 7, when the bin cover 52 is in the closed state, there is a gap between the fourth limiting portion 54 and the second limiting portion 734, that is, the sliding member 73 and the fourth limiting portion 54 are in a non-contact state, to ensure that the sliding member 73 will not touch the connecting portion 53 and the fourth limiting portion 54 during the sliding process.

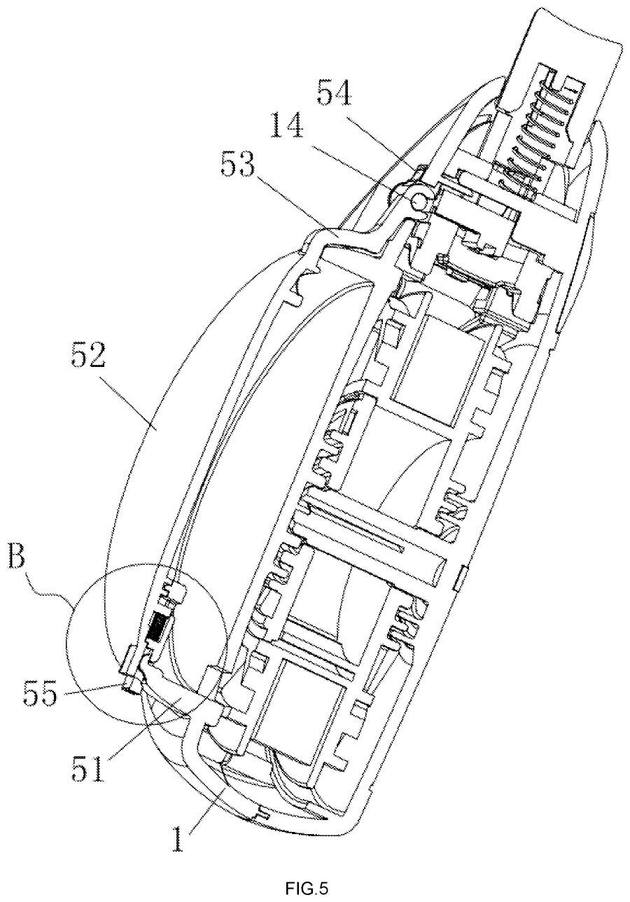

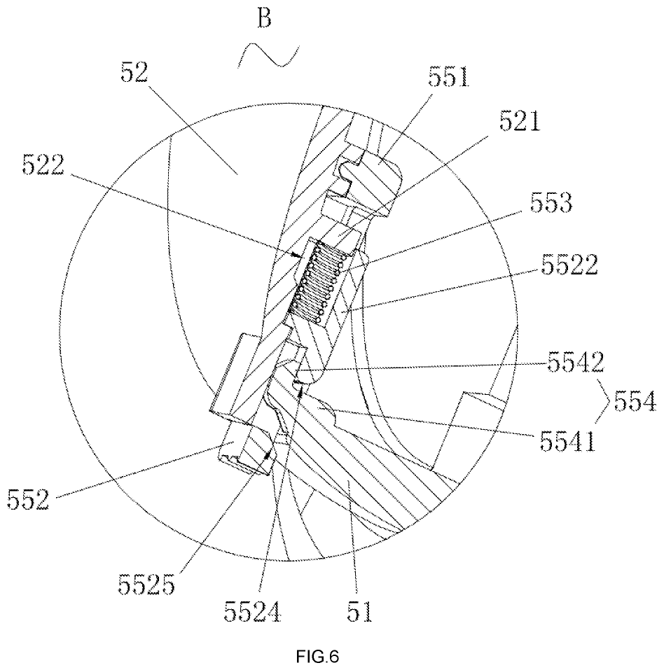

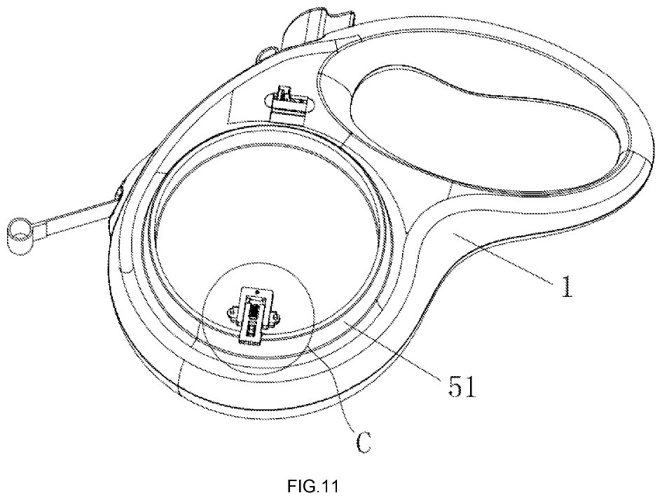

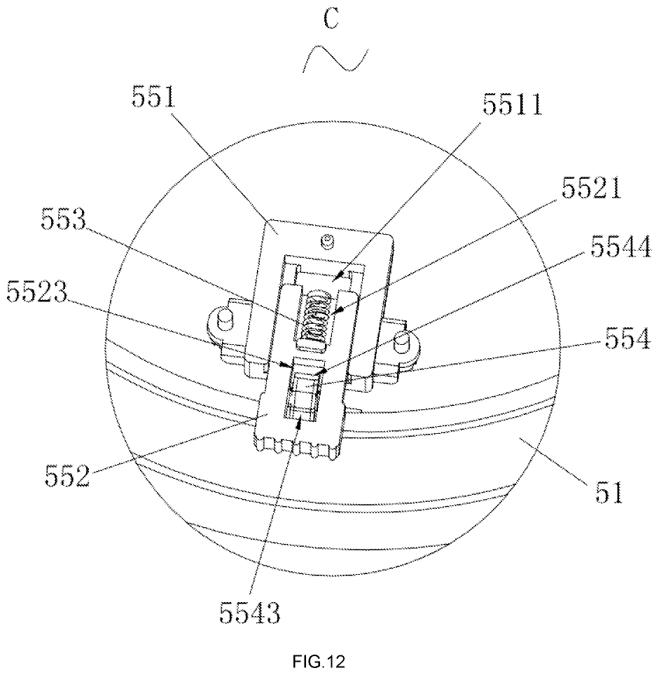

Referencing to FIG. 5, FIG. 6, FIG. 11 and FIG. 12, a further implementation method of an embodiment, wherein the switch assembly 55 comprises a base 551, a button 552, a second elastic member 553, and a protrusion 554. Wherein the base 551 is arranged on the bin cover 52, the base 551 has a first accommodation groove 5511 arranged, the button 552 is arranged on the first accommodation groove 5511, and slidably connected to the base 551. Wherein the button 552 has a second accommodation groove 5521 arranged, the second elastic member 553 is arranged in the second accommodation groove 5521, and one end of the second elastic member 553 connects to the button 552, another end of the second elastic member 553 connects to the bin cover 52. The protrusion 554 is arranged on the bin body 51, and the bin cover 52 is engaged with the protrusion 554 through the button 552.

Further, the protrusion 554 comprises a first section 5541 and a second section 5542, the first section 5541 connects to the bin body 51, the second section 5542 connects to the first section 5541. The button 552 further comprises a buckle 5522 and a slot 5523, the buckle 5522 is arranged on a bottom of the button 552, the slot 5523 is arranged on an end of the button 552 away from the base 551. Specifically, the buckle 5522 close to the slot 5523 has a first curved surface 5524 arranged on one end, the second section 5542 has a first inclined surface 5544 arranged, the first section 5541 has a second curved surface 5543 arranged, and the button 552 has a second inclined surface 5525 arranged. In one implementation method, the elastic member may be a compression spring, when it is needed to close the bin cover 52, that is, during a process of engaging the bin cover 52 and the bin body 51, or that is, during a process of the buckle 5522 slides downwards along the first inclined surface 5544 through the first curved surface 5524 and abuts against the second section 5542, and the slot 5523 passes through the protrusion 554 to make the protrusion 554 be accommodated in the slot 5523, the second inclined surface 5525 on the button 552 and the second curved surface 5543 on the first section 5541 is able to prevent the button 552 and the protrusion 554 from colliding and interfering, making the button 552 be able to slide down along the first inclined surface 5544 and abut against the second section 5542. It should be noted that, a surface normal of the second curved surface 5543 is outward, If the button 552 is touched, the button 552 will move outward, opposite to a movement of the first curved surface 5524 on the first inclined surface 5544, and the button 552 is not able to move.

When closing the storage bin 5, that is, during a process of closing the bin cover 52 and the bin body 51, when the bin cover 52 is closed to a very small size, the button 552 contacts with the second section 5542, the button 552 generates a retraction under an action of an reaction force, making the bin cover 52 be able to be closed, and the compression spring be compressed after being forced. After the protrusion 554 is accommodated in the slot 5523, the buckle 5522 abuts against In the second section 5542, the external force received by the compression spring disappears, and the compression spring rebounds and drives the button 552 to rebound, making the button 552 and the protrusion 554 be buckled together tightly, thereby ensuring the bin cover 52 and the bin body 51 being in a closed state and not easy to detach. In addition, the switch assembly 55 has a compact structure, and the elastic member is arranged transversely to the bin cover 52, which is able to greatly reduce an overall thickness of the shell 1. Referring to FIG. 5 and FIG. 6, a further implementation method of an embodiment, wherein the bin cover 52 further has a third mounting portion 521 and a third accommodation groove 522 arranged on a side of the third mounting portion 521. The second elastic member 553 is abutting against the third mounting portion 521 and partially accommodated in the third accommodation groove 522, so it is able to further reduce the overall thickness of the shell 1, making a product in a whole lighter and thinner.

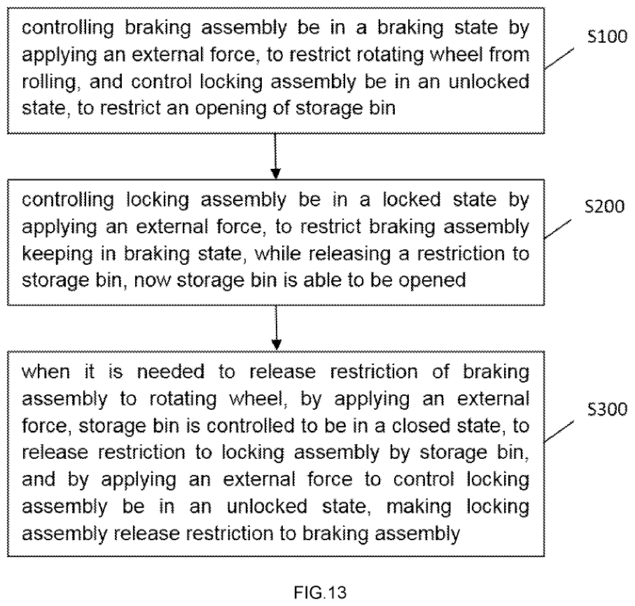

For a better understanding of the present disclosure, referencing to FIG. 13, the present disclosure further provides an embodiment on a storage bin opening control method of the pet tractor, which is applied to the pet tractor with the storage bin as described above, the method comprises:

S100, controlling the braking assembly to be in a braking state by applying an external force, to restrict the rotating wheel from rolling, and control the locking assembly to be in an unlocked state, to restrict an opening of the storage bin;

Specifically, by applying an external force to control the braking assembly to be in a braking state, to limit the rotation wheel from rolling, the traction rope is not being able to be stretched or retracted, while the locking assembly is in an unlocked state, the bin cover of the storage bin cannot be opened

S200, controlling the locking assembly to be in a locked state by applying an external force, to restrict the braking assembly keeping in the braking state, while releasing a restriction to the storage bin, now the storage bin is able to be opened;

Specifically, by applying an external force, the locking assembly is controlled to be in a locked state, to make the braking assembly be able to keep in the braking state, now the locking assembly releases the restriction to the storage bin, the storage bin is able to be opened or closed.

S300, when it is needed to release the restriction of the braking assembly to the rotating wheel, by applying an external force, the storage bin is controlled to be in a closed state, to release the restriction to the locking assembly by the storage bin, and by applying an external force to control the locking assembly to be in an unlocked state, making the locking assembly release the restriction to the braking assembly;

Specifically, when the braking assembly is in a non-braking state, and the locking assembly is in the unlocked state, the rotation wheel rolls without any restriction, the locking assembly 6 restricts the storage bin from being opened, when the storage bin is in an opened state, the storage bin restricts the locking assembly from keeping in a locked state. Thus when the retraction rope needs to be extended or retracted, it requires to release the restriction to the rotation wheel, due to a restriction action of the bin cover to the locking assembly, it needs to close the bin cover first, then control the locking assembly to be in the unlocked state by applying an external force, to make the braking assembly be able to release the restriction to the rotation wheel, after the braking assembly releases the restriction to the rotation wheel, the rotation wheel will be able to make a rolling under a drag of the traction rope, the traction rope is also able to achieve an extension and a retraction.

All above, the present disclosure provides a pet tractor with a storage bin and a storage bin opening control method, the pet tractor comprises: a shell; a rotating wheel, the rotating wheel is arranged on the shell, and the rotating wheel has a traction rope arranged, the rotating wheel is applied to driving the traction rope to extend or contract; a storage bin, the storage bin is arranged on one side of the shell; a braking assembly, the braking assembly is arranged on the shell and above the rotating wheel, applied to limiting the rotating wheel to roll; a locking assembly, the locking assembly is arranged on the shell and located at one side close to the braking assembly, applied to controlling the braking assembly to be in a braking state, and controlling the storage bin to be opened and closed; wherein when the braking assembly is in a braking state and the locking assembly is in an unlocked state, the braking assembly abuts against the rotating wheel, the braking assembly restricts the rotating wheel from rolling, and the locking assembly restricts the storage bin from being opened; when the braking assembly is in a braking state and the locking assembly is in a locked state, the braking assembly abuts against the rotating wheel, the locking assembly abuts against the braking assembly, and the locking assembly keeps the braking assembly in a braking state, while releasing a restriction on the storage bin, after the storage bin is opened, the storage bin will restrict the locking assembly to be released from the locked state. The pet tractor with the storage bin provided in the present disclosure, only when the braking assembly is in the braking state and the locking assembly is in the locking state, can the storage bin be opened, at a same time, after the storage bin is opened, the storage bin can also restrict the locking assembly to be released from the locked state, so that when the pet owner is operating the storage bin, it is able to avoid the rotating wheel from rolling suddenly and causing the traction rope extend or retract in a sudden before making hurts to the pet owner, thus improving a usage safety of the pet tractor with the storage bin.

It should be understood that, the application of the present disclosure is not limited to the above examples listed. Ordinary technical personnel in this field can improve or change the applications according to the above descriptions, all of these improvements and transforms should belong to the scope of protection in the appended claims of the present disclosure.

1. A pet tractor with a storage bin, wherein comprising:
a shell;
a rotating wheel, the rotating wheel is arranged on the shell, and the rotating wheel has a traction rope arranged, the rotating wheel is applied to driving the traction rope to extend or contract;
a storage bin, the storage bin is arranged on one side of the shell;
a braking assembly, the braking assembly is arranged on the shell and above the rotating wheel, applied to limiting the rotating wheel from rolling;
a locking assembly, the locking assembly is arranged on the shell and located at one side of the braking assembly, applied to controlling the braking assembly to be in a braking state, and controlling the storage bin to be opened and closed;
wherein when the braking assembly is in a braking state and the locking assembly is in an unlocked state, the braking assembly restricts the rotating wheel from rolling, the braking assembly abuts against the rotating wheel, and the locking assembly restricts the storage bin from being opened; when the braking assembly is in a braking state and the locking assembly is in a locked state, the braking assembly abuts against the rotating wheel, the locking assembly abuts against the braking assembly, and the locking assembly keeps the braking assembly in a braking state, while releasing a restriction to the storage bin, and after the storage bin is opened, the storage bin will restrict the locking assembly from being released from the locked state.

2. The pet tractor with the storage bin according to claim 1, wherein the locking assembly comprises:
a first rotating shaft, the first rotating shaft is arranged on the shell;
a locking member, the locking member is arranged on the first rotating shaft, and a top end of the locking member extends out of the shell while locating on a side of the braking assembly;
a sliding member, the sliding member is arranged on the shell and movably connected with the locking member, the sliding member passes through the braking assembly, and the sliding member may move laterally in the braking assembly through the locking assembly.

3. The pet tractor with the storage bin according to claim 2, wherein the sliding member comprises:
a slider body, the slider body passes through the braking assembly, and both ends of the slider body are arranged on the shell; a cantilever, the cantilever is arranged on both sides of the slider body, the sliding member connects rotatably with the locking member through the cantilever; a first limiting portion, the first limiting portion is arranged at a bottom of the slider body;
wherein after the sliding member moves laterally for a certain distance toward the braking assembly through the locking member, the first limiting portion will abut against the braking assembly to keep the braking assembly in the braking state;
a second limiting portion, the second limiting portion is arranged on the slider body and located on a side of the slider body close to the storage bin;
wherein, when the locking assembly is in the unlocked state, the sliding member is in an initial position, and the second limiting portion is applied to restricting the storage bin from being opened, after the sliding member moves laterally toward the braking assembly through the locking member, the second limiting portion releases the restriction on the storage bin.

4. The pet tractor with the storage bin according to claim 3, wherein the pet tractor with the storage bin further comprising:
a first supporting portion, the first supporting portion is arranged on the shell; the first supporting portion has a first groove and a second groove arranged, the second groove connects to the first groove; the slider body passes through the first groove;
a second supporting portion, the second supporting portion is arranged on the shell; the second supporting portion has a third groove arranged, the slider body passes through the third groove;
the slider body has a first limiting rib adapted to the second groove; wherein, when the sliding member moves laterally toward the braking assembly through the locking member, the first limiting rib is engaged with the second groove.

5. The pet tractor with the storage bin according to claim 3, wherein the braking assembly comprises:
a braking member, a top end of the braking member extends out of the shell and locates on a side of the locking member; wherein the braking member has an accommodation cavity arranged;
a first elastic member, the first elastic member is arranged in the accommodation cavity and abuts against the shell;
a first through hole, the first through hole penetrates through the braking member and connects with the accommodation cavity; the sliding member penetrates through the first through hole and abuts against the braking member by the first limiting portion, to keep the braking assembly in a braking state;
a third limiting portion, the third limiting portion is arranged at a bottom of the braking member, the third limiting portion abuts against the rotating wheel and makes the rotating wheel stop rolling.

6. The pet tractor with the storage bin according to claim 5, wherein the pet tractor with the storage bin further comprises a third supporting portion, the third supporting portion is arranged on the shell, and located under the first elastic member, the first elastic member abuts against the third supporting portion.

7. The pet tractor with the storage bin according to claim 3, wherein the storage bin comprises:
a bin body, the bin body and the shell form an accommodating space;
a bin cover, the bin cover is arranged on the bin body;
a connecting portion, the connecting portion is arranged on the bin cover and rotatably connected with the shell;
a fourth limiting portion, the fourth limiting portion is arranged on the connecting portion, and the second limiting portion abuts against the fourth limiting portion, to limit the storage bin from being opened;
a switch assembly, the switch assembly is arranged on the bin cover and applied to controlling an opening and a closing between the bin body and the bin cover.

8. The pet tractor with the storage bin according to claim 7 wherein the switch assembly comprises:
a base, the base is arranged on the bin cover, the base has a first accommodation groove arranged;
a button, the button is arranged on the first accommodation groove, and slidably connected to the base; wherein the button has a second accommodation groove arranged;
a second elastic member, the second elastic member is arranged in the second accommodation groove, and one end of the second elastic member connects to the button, another end of the second elastic member connects to the base;
a protrusion, the protrusion is arranged on the bin body, and the bin cover is engaged with the protrusion through the button.

9. The pet tractor with the storage bin according to claim 8, wherein the protrusion comprises a first section and a second section, the first section connects to the bin body, the second section connects to the first section;
the button further comprises a buckle and a slot, the buckle is arranged on a bottom of the button, the slot is arranged on an end of the button away from the base; when the button and the protrusion are engaged, the protrusion is accommodated in the slot, and the buckle abuts against the second section.

10. A storage bin opening control method of the pet tractor according to claim 1, the control method comprises a plurality of steps:
controlling the braking assembly to be in a braking state by applying an external force, to restrict the rotating wheel from rolling, and control the locking assembly to be in an unlocked state, to restrict an opening of the storage bin;
controlling the locking assembly to be in a locked state by applying an external force, to restrict the braking assembly keeping in the braking state, while releasing a restriction to the storage bin, now the storage bin is able to be opened;
when it is needed to release the restriction of the braking assembly to the rotating wheel, by applying an external force, the storage bin is controlled to be in a closed state, to release the restriction to the locking assembly by the storage bin, and by applying an external force to control the locking assembly to be in an unlocked state, making the locking assembly release the restriction to the braking assembly;
wherein, when the braking assembly is in a non-braking state and the locking assembly is in an unlocked state, the rolling of the rotating wheel will not be restricted, and the locking assembly will restrict the storage bin from opening; when the storage bin is in an open state, the storage bin restricts the locking assembly to maintain the locked state.
